(19) United States
(12) Patent Application Publication
(10) Pub. No.: US 2018/0009560 A1
(43) Pub. Date: Jan. 11, 2018

(54) LABELLING DEVICE AND SYSTEM COMPRISING SUCH DEVICE

(71) Applicant: Erasmus University Medical Center Rotterdam, Rotterdam (NL)

(72) Inventor: Hans de Bruin, Rotterdam (NL)

(21) Appl. No.: 15/642,813

(22) Filed: Jul. 6, 2017

(30) Foreign Application Priority Data
Jul. 7, 2016 (NL) 2017126

(51) Int. Cl. B65C 9/08; B65C 1/00; B65C 9/40; B65C 9/46

(52) U.S. Cl. CPC B65C 9/08; B65C 9/46; B65C 1/00; B65C 9/40

(57) ABSTRACT

A first aspect provides a labelling device for providing an object with a printed label. The device comprises a first transportation module, a labelling module comprising a label gripper and a gripper driving module for moving the gripper between a label pick-up position and a label application position, and a second transportation module. The labelling device further comprises a labelling processing unit arranged to instruct the first transportation module to transport the object to the labelling position, after transportation of the object to the labelling position, instruct the labelling module to have the gripper grip a label at the label pick-up position and transport the label to the label application position for application of the label to the object and after application of the label, instruct the second transportation module to transport the object away from the labelling position.

### TECHNICAL FIELD

The various aspects relate to a device for applying labels to an object. More in particular, some embodiments relate to a device for applying labels to related microscopic slides consecutively provided in a stack.

### BACKGROUND

Label printers in general are well known in the art. Label printers for high-volume printing of labels in a high-speed flow, as the Herma systems provided by the company Weber. And label printers for just supplying a printed label, like label printers provided by the company Zebra.

### SUMMARY

Label printers for high-volume printing of labels in a high-speed flow are useful in mass production processes and single label distribution systems are preferred for providing labels to be applied in a manual process. But high-volume, high-speed label printers may be too expensive for certain processes. And for such processes, applying labels by hand is not preferred to prevent the introduction of errors due to human intervention. One scenario in which this is the case is when applying labels to microscopical slides holding biological samples like human tissue. Errors in applying labels may lead to wrong diagnoses—which may have catastrophic consequences. Automation, using data held by a laboratory data management system, is preferred.

It is noted automated systems are available, directly inscribing data in the glass of the microscopical slides. Such systems are expensive and, even worse, generate glass dust. Such glass dust is very harmful to fine machinery in a laboratory and to the printer itself in particular.

It is preferred to provide an automated label system and application system that is more convenient to use, in general and in a laboratory environment in particular.

A first aspect provides a labelling device for providing an object with a printed label. The device comprises a first transportation module, a labelling module comprising a label gripper and a gripper driving module for moving the gripper between a label pick-up position and a label application position, and a second transportation module. The labelling device further comprises a labelling processing unit arranged to instruct the first transportation module to transport the object to the labelling position, after transportation of the object to the labelling position, instruct the labelling module to have the gripper grip a label at the label pick-up position and transport the label to the label application position for application of the label to the object and after application of the label, instruct the second transportation module to transport the object away from the labelling position.

By means of the label gripper, the label printed by the standard, batch printing, label printer is picked up automatically. By synchronising supply of an object by means of the first transportation module, the object is provided at a standard location for applying the label, removing any requirement for optical search and recognition of the exact position of the object. And after the label has been applied, the object is moved away, making room for another object to be provided with a label.

The label is printed separately, which reduces or even suppresses the risk of the printing process to pollute the slide or the environment.

An embodiment of the first aspect comprises a repository for holding the object, wherein the first transportation module is arranged to transport the object from the repository to the labelling position. This embodiment makes automation more convenient and efficient.

In another embodiment of the first aspect, the repository is arranged for holding a stack of objects and the first transportation module is arranged for transporting an object at the bottom of the stack to the labelling position. In such embodiments, no vertically acting actuators and further moving parts are required for levelling the top of the stack with the labelling position—or for moving an object from the top of the stack to the labelling position.

A second aspect provides a system for labelling a microscopic slide The system comprises a printer for printing labels and the labelling device according to the first aspect for applying labels printed by the printer to the objects.

An embodiment of the first aspect further comprises an input module, a data storage module and a processing unit. The input module is arranged to receive a relation between a microscopic slide and a specimen held or to be held by the microscopic slide as well as label information related to the microscopic slide. The data storage module for storing the received relations and the control processing unit arranged to instruct the printer to print the label information on a label and instruct the device to apply the printed label to the microscopic slide.

This embodiment enables proper synchronisation of the printing of the labels and moving of related slides to the labelling position for application of the related printed label.

Another embodiment of the second aspect is preferred. In this embodiment, the labelling device is a labelling device comprising a repository arranged for holding a stack of microscopic slides and the input module of the control device is arranged to receive a data set comprising records related to the stack of microscopic slide, each record comprising a relation between a microscopic slide, a specimen held or to be held by the microscopic slide and a position of the microscopic slide in the stack. In this embodiment, the control processing unit is further arranged to determine in which order each microscopic slide comprised by the stack is moved to the labelling position; and instruct the printer to print label information comprised by each record in the same order as by which order the microscopic slides comprised by the stack arrive at the labelling position.

This embodiment reduces the risk of mislabelling errors.

### BRIEF DESCRIPTION OF THE DRAWINGS

The various aspects and embodiments thereof will now be discussed in further detail in conjunction with drawings. In the drawings,

FIG. 1: shows a system for printing labels and applying the labels;

FIG. 2: shows another side view of the device for applying labels;

FIG. 3: shows a top view of the device for applying labels; and

FIG. 4: shows a flowchart.

### DETAILED DESCRIPTION

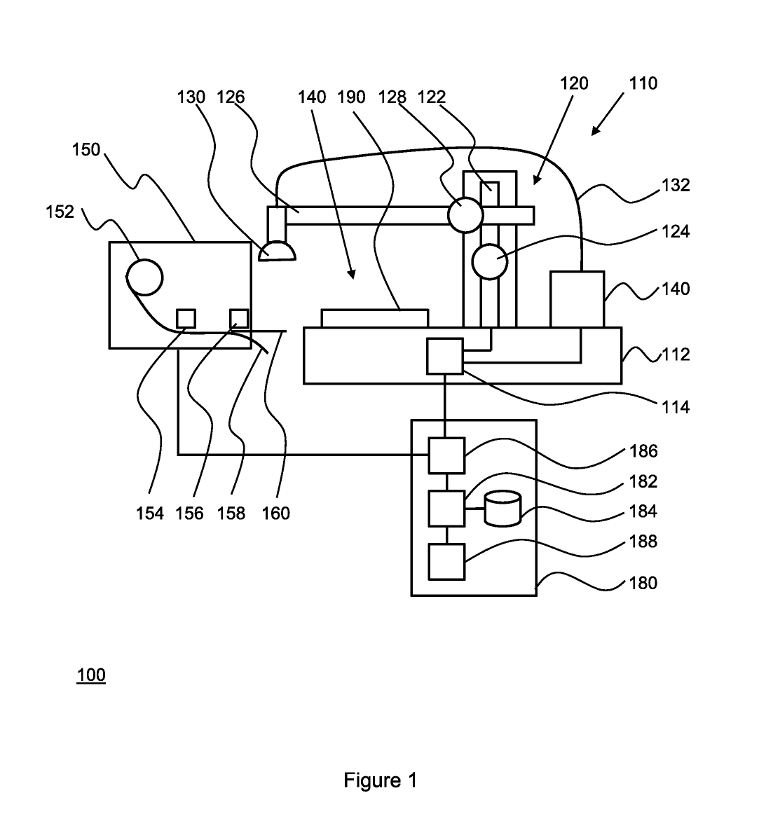

FIG. 1 shows a system 100 for printing label and applying printed labels to an object and to a microscopic slide 190 in particular. To this end, the system 100 comprises a label printer 150 for printing a label 160, a labelling device 110 for applying the label 160 to the slide 190 and a control device 180 for controlling the system 100.

The label printer 150 holds a label roll 152 comprising a label carrier 158 on which labels like the label 160 are provided, preferably by means of a glue layer for applying the label 160 to any objects. The label printer 150 further comprises a printing head 154 and a label sensor 156. The label printer 150 is in this embodiment arranged to print a text, a figure, other or a combination thereof to the label 160. No other label is printed, until the label sensor 156 detects that the label 160 has been removed from the carrier 158 and/or from the outlet of the label printer 150. If yet data to be printed arrives at or is available at the label printer 150, such data is stored in a buffer (not shown). Devices like the label printer 150 are commercially available from, for example, the company Zebra.

The labelling device 110 comprises a base 112 on which a labelling position 140 is defined, providing room for the slide 190 to be labeled. The labelling device 110 further comprises a labelling module 120, placed on the base 112. The labelling module 120 is arranged for picking up the label 160 from the printer 150 and for applying the label 160 to the slide 190. The labelling module 120 comprises a suction cup 130 for picking up the label 160. The suction cup 130 is connected to a switchable pump unit 140 via a tubing 132 for creating an under pressure within the suction cup 130. Alternatively or additionally, the labelling module 120 may comprise other means for picking up and holding the label 160, like a gripper comprising fingers or other constructions.

The labelling module 120 further comprises a vertical movement part 122, along which a horizontal movement part 126 may be moved for adjusting the vertical position of the suction cup 130. The vertical movement part 122 comprises a vertical position driver 124 for driving the vertical positing of the horizontal movement part 126. The horizontal movement part 126 comprises a horizontal position driver 128 for driving the horizontal position of the suction cup 130. The horizontal movement part 126 and the vertical movement part 122 may be driven by the horizontal position driver 128 and the vertical position driver 124, respectively. The position drivers may be regular electromotors, stepper motors, linear electromechanical actuators, other or a combination thereof. The driving may be effectuated by means of a tooth-and-rack arrangement, a helical screw arrangement, a driving belt and wheel, either toothed or not, other, or a combination thereof.

The labelling device 110 also comprises a labelling processing unit 114 for controlling the various components of the labelling device 110. More in particular, the labelling processing unit 114 is arranged for switching suction power provided by the switchable pump unit 140 on and off. The suction power is switched on when picking up the label 160 and switch off when the label 160 is or has been applied to the slide 190.

Furthermore, the labelling processing unit 114 is arranged for controlling a position of the suction cup 130 relative to the label printer 150 and the labelling position 140, thus to the slide 190. The controlling of the position of the suction cup 130 is arranged by controlling the horizontal position driver 128 and the vertical position driver 124.

The label printer 150 and the labelling device 110 are controlled by the control device 180. The control device 180 comprises a control processing unit 182, a control storage unit 184, a control peripheral communication unit 186 and a network communication unit 188. The control processing unit 182 is arranged for controlling the various components of the control device and may also be arranged for controlling the label printer 150 and the labelling device 110. More in particular, the control processing unit 182 may be arranged to coordinate operation of the label printer 150 and the labelling device 110, ensuring operation of all device of the labelling system 100 are aligned.

The storage unit 184 is arranged for storing computer executable code for enabling the control processing unit 182 as discussed through the description. Furthermore, the storage unit 184 is arranged for receiving records comprising data on the slide 190 and other slides, including, but not limited to data to be printed on labels for the slide 190. And in case multiple slides are provided to the labelling device 110 at once, the storage unit 184 is also arranged to store data related to the order in which the slides are provided to the labelling device 110. This and possibly other data is received by the control device 180 by means of the network communication unit 188. The control device 180 may be embodied as a personal computer or a dedicated computing device, for example by means of the Arduino development kit.

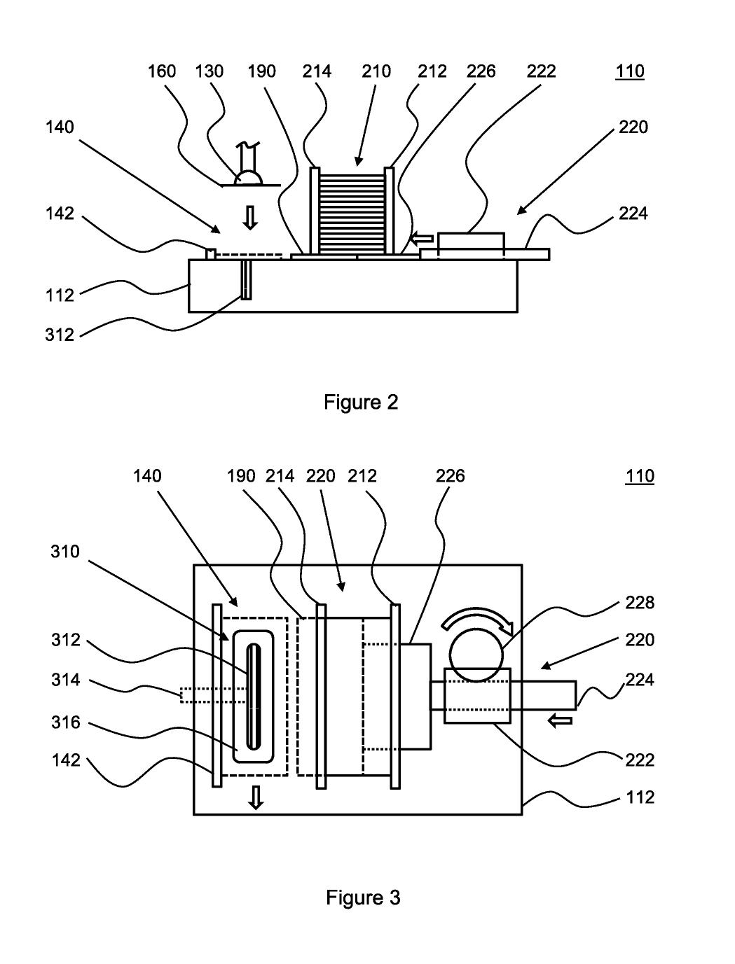

FIG. 2 shows another side view of the labelling device 110, perpendicular to the view shown by FIG. 1. FIG. 3 shows a top view of the labelling device 110.

FIG. 2 shows a start position of the labelling device 110. In addition to components shown in FIG. 1, the labelling device 110 comprises a repository 210 for holding a stack of slides, including the particular slide 190 to be labelled. The repository 210 comprises in this embodiment a first sidewall 214 and a second sidewall 212. In other embodiments, the repository may comprises more and/or other walls, for example supports for only supporting corners of the stack of slides.

The labelling device 110 further comprises a first transportation module 220 for transporting slides to the labelling position 140. The first transportation module 220 comprises a housing 222, a reciprocating arm 224 and a pusher 226 connected to an end of the reciprocating arm 224. In the embodiment shown by FIG. 3, movement of the reciprocating arm is controlled by means of a gear 228 operating in conjunction with a rack (not shown) provided in the reciprocating arm 224. The gear 228 may be driven by a regular electromotor or a stepper motor. In an alternatively embodiment, another electromechanical actuator may be used.

The pusher 226 fits underneath a narrow slit at the bottom of the repository 210. The narrow slit is wide enough for allowing the slide 190 to be slid from the repository to the labelling position. The pusher 226 is preferably as high as the slide 190. By means of the reciprocating arm 224 and the pusher 226, the slide is pushed from underneath the stack in the repository 210 to the labelling position. Preferably, the slide 190 is pushed up to an abutment 142.

At the labelling position 140, the label 160 is applied, carried by the suction cup 130. After the label 160 has been applied, the slide 190 is transported away from the labelling position by means of a second transportation module 310. The second transportation module comprises in this embodiment a wheel 312 having a rubber circumference—or a circumference provided with another material having a high friction coefficient. The wheel 312 is positioned in an opening 316 and driven by means of an axle 314 that is connected to a rotational actuator like an electromotor (not shown). The position of the wheel 312 relative to the top of the base 112 at the position of the labelling position 140 may be adjusted in particular embodiments.

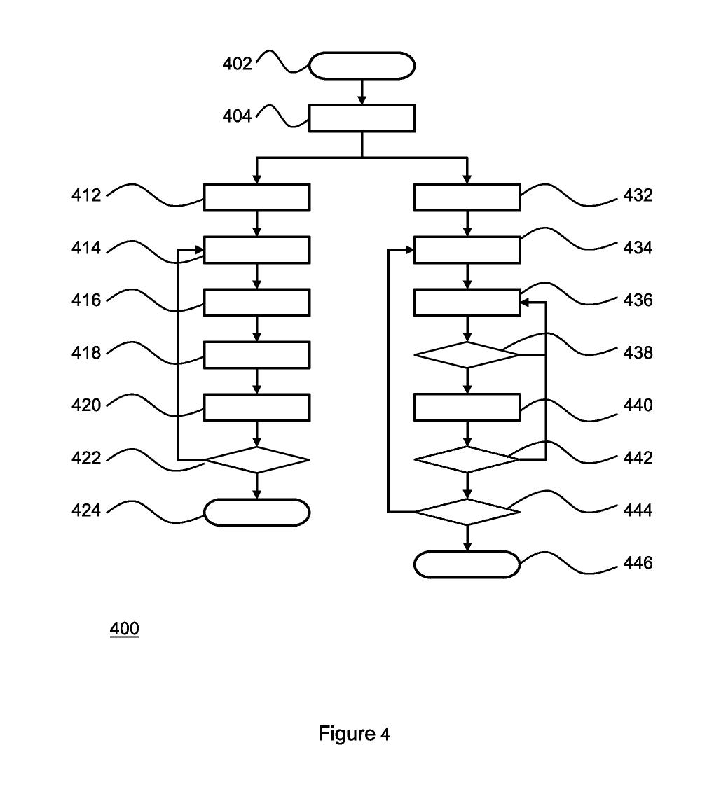

The operation of the labelling device 110 will be discussed in further detail in conjunction with FIG. 2, FIG. 3 and a flowchart 400 shown by FIG. 4. The various parts of the flowchart 400 are summarised below:

| | |
|---|---|
| 402 | start procedure |
| 404 | receive data slide order and labels |
| 412 | instruct start label application |
| 414 | transport slide |
| 416 | pick up label |
| 418 | apply label |
| 420 | transport slide away |
| 422 | slides left in repository? |
| 424 | end application process |
| 432 | send label data to printer |
| 434 | receive label data |
| 436 | check label sensor |
| 438 | printer outlet free? |
| 440 | print label |
| 442 | all labels printed? |
| 444 | data offered? |
| 446 | end printing |

The flowchart 400 comprises a common start and two branches. The left branch relates to the labelling device 110 and the right branch relates to the label printer 150.

The process starts in a terminator 402 and continues with the reception of data related to the slides in the repository 210 in step 404. Following step 404, the process branches to step 412 in which the label application device 110 is instructed to pick up the label 160 to the slide 190. The process also branches to step 432, in which label data is sent to the label printer 150. The control device 180 and the control processing unit 182 instruct the label printer 150 via the peripheral communication unit 186 to firstly print a label for the slide at the bottom of the stack in the repository 210, followed by the second lowest slide in the stack.

Label data to be printed is received by the label printer 150 in step 434. Having received the data, the printer 150 reads in step 436 data of the label sensor 156. In step 438, it is checked whether a label is present, based on the data of the label sensor 156. If a label is present, the process loops back to step 436. If no label is present, decision 438 continues to the process to step 440, in which a label is printed by means of the printing head 154.

Meanwhile, the slide 190 is transported to the labelling position 140 in step 414 by means of the first transportation module 120. In step 416, the label 160 is picked up from the printer 150 by means of the suction cup 130. The position of the suction cup 130 is controlled by means of various actuators, as discussed above. These actuators may be controlled by means of the labelling processing unit 114, the control processing unit 180, another processing unit or a combination thereof. This also applies to other actuators comprised by the system 100.

The label 160 picked up is applied to the slide 190 in step 418, by further control of the position of the suction cup 130. After application of the label 160 to the slide 190, the process continues to step 420 in which the second transportation module 310 transports the slide 190 away from the labelling position 140. This may be in the direction indicated by the arrow at the lower left of FIG. 3. Additionally, the labelling device 110 may comprise an additional wheel, for example like the wheel 312, provided above the slide 190 while transported away, for applying additional pressure to the applied label 160 to ensure proper adhesion.

After the slide 190 has been transported away from the labelling position 140, the process checks in step 422 whether any slides are left in the repository 210. If this is the case, the process branches back to step 414. If no more slides are left, the process continues to terminator 424 in which the process branch for the labelling device 110 ends.

Checking whether the repository 210 still comprises any slides may be determined by means of sensors. Alternatively or additionally, this is determined by means of the records received earlier. If the amount of slides transported equals the amount of records received by the control device 180 as discussed above, it may be determined in decision 422 that all slides have been processed. Alternatively or additionally, sensors are used for checking whether any slides are left in the repository 210 (qualitatively) or how much slides are left in the repository 210 (quantitatively).

As to the branch related to the label printer 150, after the label 160 has been printed, it is checked whether all labels have been printed for which data has been received by the printer 150. If this is not the case, the process branches back to step 436 for checking whether the outlet of the printer 150 is empty or not. If all data present in the buffer of the label printer 150 is printed and the buffer is empty, the process continues to step 444 in which it is checked whether the control device 180 offers any further data for printing labels to the label printer 150. If such is the case, the process branches back to step 434 for receiving the data offered. If the buffer is empty and no more data is offered to the printer 150, the process proceeds to terminator 448 in which the branch for the label printer 150 ends.

The labels 160 may be provided to the slide 190 after or prior to applying a specimen to the slide 190. In the first scenario, a proper administration needs to be provided on the stacking of the slides 190 in the repository 210. The order of the slides 190 is the repository 210 needs to be synchronised with the order of the labels 160 that are printed. The administration is handled by the control device 180.

In the second scenario, an operator providing specimen to the slides 190 needs to take care the a specimen is applied to the slide that matches with the information provided on the label 160 of slide 190. Alternatively, the label 160 comprises a unique code and the operator provides a link between the unique code on the label 160 and the specimen provided on the slide 190.

In the process depicted by the flowchart 400, further measures may be applied for ensuring synchronisation between both branches. For example, slides to be printed or specimen held or to be held by the slides may be inspected visually and compared to data for example held by the record applicable to the slide. If inspection data does not match with data comprised by the record, an error code may be issued. As another option, transportation of a slide to the labelling position may be synchronised with the printing of a label to be applied to the transported slide.

The labelling device 110 may furthermore be equipped with one or more additional sensors for determining positions of the various moving parts of the labelling device 110, including, but not limited to, the reciprocating arm 224 and the pusher 226, the vertical movement part 122, the horizontal movement part 126, parts of the second transportation module 310, other, or a combination thereof.

Up to now, the system 100 has been discussed for printing labels for microscopic slides, including the labelling device 110 dedicated to handling of such slides. With some modifications, the system 100 may be made suitable for printing labels and applying such labels to other objects.

Furthermore, also means of transportation for the slide 190 may be employed other than those discussed above. The structure of the labelling device 110 may be modified to swap the first transportation module 220 and the second transportation module 310. Alternatively, the setup with the wheel 312 is also used for the first transportation module 220 or the setup with the pusher 226 is also used for the second transportation module 320. In yet other embodiments, conveyor belts, moving arms with grippers and/or suction cups and many other transportation means suitable for transporting the microscopic slide 190 or—in case applicable—other objects can be handled may be used. In case of using a conveyor belt, it may even be possible to employ a single conveyor belt instead of the first transportation module 220 and the second transportation module 320.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

In the description above, it will be understood that when an element such as layer, region or substrate is referred to as being “on” or “onto” another element, the element is either directly on the other element, or intervening elements may also be present.

Furthermore, the invention may also be embodied with less components than provided in the embodiments described here, wherein one component carries out multiple functions. Just as well may the invention be embodied using more elements than depicted in the Figures, wherein functions carried out by one component in the embodiment provided are distributed over multiple components.

A person skilled in the art will readily appreciate that various parameters disclosed in the description may be modified and that various embodiments disclosed and/or claimed may be combined without departing from the scope of the invention.

1. Labelling device for providing an object with a printed label, the device comprising:
A first transportation module;
A labelling module comprising a label gripper and a gripper driving module for moving the gripper between a label pick-up position and a label application position;
A second transportation module; and
A labelling processing unit arranged to:
Instruct the first transportation module to transport the object to a labelling position;
After transportation of the object to the labelling position, instruct the labelling module to have the gripper grip a label at the label pick-up position and transport the label to the label application position for application of the label to the object; and
After application of the label, instruct the second transportation module to transport the object away from the labelling position.

2. Device according to claim 1, wherein the first transportation module and the second transportation comprise at least one of the following:
A linear actuator for pushing the object from a first position to a second position in a substantially linear direction;
A rotating member driven by a rotating actuator for moving the object from the first position to the second position in a substantially linear direction;
A conveyor belt actuator for moving the object from the first position to the second position in a substantially linear direction;
Wherein:
For the first transportation module, the second position corresponds to the labelling position; and
For the second transportation module, the first position corresponds to the labelling position.

3. Device according to claim 1, further comprising a repository for holding the object, wherein the first transportation module is arranged to transport the object from the repository to the labelling position.

4. Device according to claim 3, wherein the repository is arranged for holding a stack of objects and the first transportation module is arranged for transporting an object at the bottom of the stack to the labelling position.

5. Device according to claim 1, wherein the gripper driving module comprises a vertical driver for moving the gripper in a substantially vertical direction and a horizontal driver for moving the gripper in a substantially horizontal direction.

6. Device according to claim 1, wherein the gripper comprises a suction cup.

7. Device according to claim 6, wherein the suction cup is arranged to be connected to an under pressure source for providing a first pressure in the suction cup that is lower than ambient pressure.

8. Device according to claim 1, wherein the gripper is a mechanical gripper.

9. Device according to claim 1, wherein the object is a microscopic slide for holding a specimen.

10. System for labelling a microscopic slide, the system comprising:
A printer for printing labels; and
The labelling device according to any of the preceding claims for applying labels printed by the printer to the microscopic slide.

11. System according to claim 10, further comprising a control device comprising:
An input module arranged to receive a relation between a microscopic slide and/or a specimen held or to be held by the microscopic slide as well as label information related to the microscopic slide;
A data storage module for storing the received relations;
A control processing unit arranged to:
Instruct the printer to print the label information on a label; and
Instruct the device to apply the printed label to the microscopic slide.

12. System according to claim 11, wherein:
The labelling device is a labelling device according to claim 6;
The repository is arranged for holding a stack of microscopic slides;
The input module of the control device is arranged to receive a data set comprising records related to the stack of microscopic slide, each record comprising a relation between a microscopic slide, a specimen held or to be held by the microscopic slide and a position of the microscopic slide in the stack; and
Wherein the control processing unit is further arranged to:
Determine in which order each microscopic slide comprised by the stack is moved to the labelling position; and
Instruct the printer to print label information comprised by each record in the same order as by which order the microscopic slides comprised by the stack arrive at the labelling position.

13. System according to claim 12, wherein:
The printer comprises a sensor for detecting whether a printed label has been taken from the printer and the printer is arranged for printing a subsequent label only after a printed label has been taken; and
The control processing unit is arranged to send instructions for printing labels in the determined order to the printer in one communication session.
